(19) United States
(12) Patent Application Publication
(10) Pub. No.: US 2014/0001968 A1
(43) Pub. Date: Jan. 2, 2014

(54) CIRCUIT AND METHOD FOR CONTROLLING LIGHT EMITTING DIODE

(71) Applicant: Jianbo SUN, Shanghai (CN)

(72) Inventor: Jianbo SUN, Shanghai (CN)

(73) Assignee: BCD Semiconductor Manufacturing Limited

(21) Appl. No.: 13/596,332

(22) Filed: Aug. 28, 2012

(30) Foreign Application Priority Data
Jun. 28, 2012 (CN) 201210219812.6

(51) Int. Cl. H05B 37/02

(52) U.S. Cl. 315/186

(57) ABSTRACT

A method for controlling a current flowing through one or more light emitting diodes (LEDs) comprising receiving a Pulse Width Modulation (PWM) control signal, which includes rising and falling edges; receiving a first voltage signal; generating a second voltage signal based on the PWM control signal and the first voltage signal, wherein the second voltage increases gradually in response to one of the rising and falling edges of the PWM signal and decreases gradually in response to the other of the rising and falling edges of the PWM signal; and providing a current to the one or more LEDs, wherein the current varies gradually according to the second voltage.

### CROSS REFERENCE TO RELATED APPLICATION

This application claims the benefit of priority to Chinese Patent Application No. 201210219812.6, filed with the Chinese Patent Office on Jun. 28, 2012, and entitled “Circuit and Method for Controlling Light Emitting Diode,” which is hereby incorporated by reference in its entirety.

### TECHNICAL FIELD

The subject matter of the present application relates to methods and circuits for controlling Light Emitting Diodes (LEDs), in particular, to methods and circuits for controlling the light intensity of LEDs by integrated circuits having a soft dimming capability.

### BACKGROUND INFORMATION

Many electronic products including cellular phones, Personal Digital Assistant (PDA) devices, electronic books (e-books), digital cameras, MP3 players, Global Positioning Systems (GPS), and digital photo frames use Liquid Crystal Displays (LCDs). Many of these products use Light Emitting Diodes (LEDs) to provide backlight to the LCDs. An LED control circuit is often used to drive the LEDs to turn the lights on or off or to obtain a desired light intensity. The LED control circuit can include a DC-to-DC converter, which converts a direct current (DC) signal from one voltage level to another. A DC-to-DC converter can also regulate an output current flowing through the LEDs, and thus, adjust the light intensity of the LEDs.

The DC-to-DC converter of the LED control circuit can be a boost or buck converter, and include a Pulse Width Modulation (PWM) circuit. In such a circuit, a PWM signal is an input to the DC-to-DC converter. The PWM signal, which is an electrical pulse signal, can have, for example, a high voltage level and a low voltage level. A frequency of the electrical pulse signal can be fixed but the width of the electrical pulse signal can be varied. By varying the pulse width, an average value of the current flowing through the LEDs can be varied accordingly, thus adjusting the light intensity of the LEDs. But changing the pulse width can cause a severe output voltage fluctuation.

Therefore, there is a need to avoid severe and sudden fluctuations of the output voltage and current of the LED control circuit. That is, it is desirable to increase or decrease the output current in a controllable manner.

### SUMMARY

The present disclosure provides a method for controlling a current flowing through one or more light emitting diodes (LEDs). According to one embodiment, the method includes receiving a Pulse Width Modulation (PWM) signal, which includes rising and falling edges; receiving a first voltage signal; generating a second voltage signal based on the PWM signal and the first voltage signal, wherein the second voltage increases gradually in response to one of the rising and falling edges of the PWM signal and decreases gradually in response to the other of the rising and falling edges of the PWM signal; and providing a current to the one or more LEDs, wherein the current varies gradually according to the second voltage.

According to a further embodiment, a method for controlling a current flowing through one or more light emitting diodes (LEDs) includes receiving a Pulse Width Modulation (PWM) signal, which includes rising and falling edges; receiving a voltage signal; generating a first current based on the voltage signal; generating a second current based on the first current and the PWM signal, wherein the second current increases gradually in response to one of the rising and falling edges of the PWM signal and decreases gradually in response to the other of the rising and falling edges of the PWM signal; and providing a third current to the one or more LEDs, wherein the third current varies gradually according to the second current.

The present disclosure further provides a system for controlling a current flowing through one or more light emitting diodes (LEDs). According to one embodiment, the system includes a voltage regulator configured to receive a first voltage signal; a current regulator coupled to the voltage regulator and configured to generate a second voltage signal based on a PWM signal and the first voltage signal, wherein the second voltage increases gradually in response to one of the rising and falling edges of the PWM signal and decreases gradually in response to the other of the rising and falling edges of the PWM signal; and a current controller configured to provide a current to the one or more LEDs, wherein the current varies gradually according to the second voltage.

According to a further embodiment, a system for controlling a current flowing through one or more light emitting diodes (LEDs) includes a voltage regulator configured to receive a voltage signal; a current regulator configured to generate a first current based on the voltage signal and a second current based on the first current and a PWM control signal, wherein the second current increases gradually in response to one of the rising and falling edges of the PWM signal and decreases gradually in response to the other of the rising and falling edges of the PWM signal; and a current controller configured to provide a third current to the one or more LEDs, wherein the third current varies gradually according to the second current.

### BRIEF DESCRIPTION OF THE DRAWINGS

FIG. 1 is a block diagram of an exemplary LED control system.

FIG. 2 is a schematic diagram illustrating an exemplary embodiment of an LED current controller shown in FIG. 1.

FIG. 3 is a block diagram of an exemplary LED control system with an LED current regulator.

FIG. 4A is a schematic diagram of an exemplary LED current regulator shown in FIG. 3.

FIG. 4B is a schematic diagram of an exemplary multiplexer shown in FIG. 4A.

FIG. 4C is a schematic diagram of an exemplary LED current regulator shown in FIG. 3.

FIG. 5A is an exemplary timing diagram illustrating timing relations between a PWM input signal, an LED current, and a dimming control signal, corresponding to the dimming control circuit shown, for example, in FIG. 1.

FIG. 5B is an exemplary timing diagram illustrating timing relations between a PWM input signal, an LED current, and a dimming control signal, corresponding to the LED control system shown, for example, in FIG. 3.

### DETAILED DESCRIPTION OF THE EMBODIMENTS

Reference will now be made in detail to the exemplary embodiments consistent with the embodiments disclosed herein, the examples of which are illustrated in the accompanying drawings. Wherever possible, the same reference numbers will be used throughout the drawings to refer to the same or similar parts.

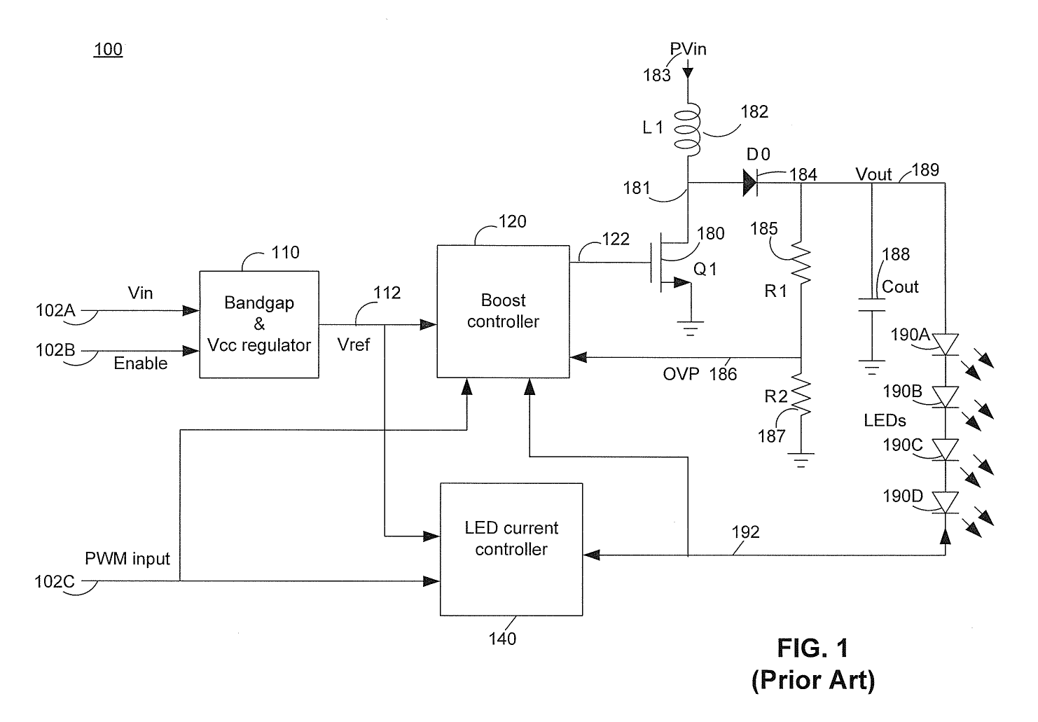

FIG. 1 is a block diagram of an exemplary LED control system 100. LED control circuit 100 can have one or more input signals including, for example, a voltage input signal Vin 102A, an enable signal 102B, and a PWM input 102C. LED control circuit 100 can also include a bandgap and Vcc regulator 110, a boost controller 120, an LED current controller 140, a transistor Q1 180, an inductor 182, a DC voltage input Pvin 183, a diode 184, two resistors R1 185 and R2 187, an output capacitor 188, and one or more LEDs 190A˜190D. In this exemplary embodiment, a boost controller is used as an example. A person having ordinary skill in the art should appreciate that a buck controller or a buck-boost controller can also be used.

As shown in FIG. 1, bandgap and Vcc regulator 110 receives external input signals including Vin 102A as an input DC voltage and enable signal 102B. When enable signal 102B is ON, for example, bandgap and Vcc regulator 110 can generate a reference voltage Vref 112 and an internal power supply Vcc (not shown in FIG. 1). The internal power supply Vcc provides a more stable power supply compared to outside power supplies. The reference voltage Vref 112, generated from bandgap and Vcc regulator 110, is later provided to boost controller 120 and LED current controller 140.

In addition to the reference voltage Vref 112, boost controller 120 can receive a PWM input signal 102C and a feedback signal 192. Boost controller 120 can generate a control signal 122 as its output signal to control the transistor Q1 180 through the connection to the control terminal of transistor Q1 180.

As shown in FIG. 1, LED current controller 140 receives PWM input 102C and Vref 112 as its input signals. LED current controller 140 is electrically coupled to LEDs 190A˜190D through connection 192. As described in detail below, LED current controller 140 can supply or suppress current flowing through LEDs 190A˜190D. In some embodiments, the current flowing through connection 192, i.e., the current flowing through LEDs 190A˜190D, can also be provided directly or indirectly as a feedback signal to boost controller 120.

Transistor Q1 180 can be a Metal-Oxide-Semiconductor Field Effect Transistor (MOSFET) device, which includes a gate terminal electrically coupled to signal 122, which is generated from boost controller 120. Thus, transistor Q1 180 can be turned on or off depending on the voltage level of the control signal 122. Transistor Q1 180 further includes a source terminal electrically coupled to a ground potential and a drain terminal electrically coupled to a first terminal of inductor 182 and a first terminal (e.g. anode) of diode 184. Inductor 182 includes a second terminal, which receives an input DC voltage PVin 183. When transistor Q1 180 is turned off, Pvin 183 provides a voltage 181 to LEDs 190A˜190D through diode 184. When transistor Q1 180 is turned on, however, the voltage 181 can be pulled toward a lower value or a ground potential.

Further, in FIG. 1, Diode 184 includes a second terminal electrically coupled to a first terminal of capacitor 188. A second terminal of capacitor 188 is electrically connected to the ground potential. Diode 184 and capacitor 188 can stabilize the output voltage Vout 189. For example, when transistor Q1 180 is turned off, Pvin 183 provides a current flowing through diode 184 to charge capacitor 188. When transistor Q1 180 is turned on and thus the voltage 181 is pulled toward the ground potential, diode 184 cuts off the current path from capacitor 188 to transistor Q1 180. Capacitor 188 releases its electrical charge through LEDs 190A˜190D, thus temporarily maintaining the current flowing through LEDs 190A˜190D. In some embodiments, the capacitance value can be large in order to prevent or reduce the sudden change of the output voltage Vout 189, i.e., reduce the output voltage fluctuation.

The second terminal (e.g. a cathode terminal) of diode 184 is also electrically coupled to a voltage divider, which can include resistors R1 185 and R2 187. Resistors R1 185 and R2 187 can generate a voltage division and produce an overvoltage protection signal OVP 186. OVP 186 is provided to boost controller 120 as a feedback signal so that boost controller 120 can provide overvoltage protection for LEDs 190A˜190D by adjusting the voltage of control signal 122 accordingly.

As shown in FIG. 1, the second terminal of diode 184 is also electrically coupled to a first terminal of LED 190A in LEDs 190A˜190D. It is readily appreciated that the number of LEDs is not limited to four and can be any number desired. In some embodiments, LEDs 190A˜190D can be sequentially connected as shown in FIG. 1. LEDs 190A˜190D are electrically coupled to LED current controller 140, which can form a part of the current path from Pvin 183 and can sense the current flowing through LEDs 190A˜190D.

In operation, when PWM input 102C is high, i.e., the input pulse voltage level is high, both boost controller 120 and LED current controller 140 can be turned on. Transistor Q1 180 can be turned off so that the current flowing through LEDs 190A˜190D is at a high level. Conversely, if PWM input 102C is low, i.e., the input pulse voltage level is low, both boost controller 120 and LED current controller 140 can be turned off.

When transistor Q1 180 is turned on and the voltage of signal 181 is pulled toward the ground potential, capacitor 188 can temporarily maintain the voltage Vout 189 or reduce its rate of decay. As discussed above, however, a dimming control circuit implemented by using a PWM input, which has two voltage levels, exhibits output voltage fluctuations and a ripple effect.

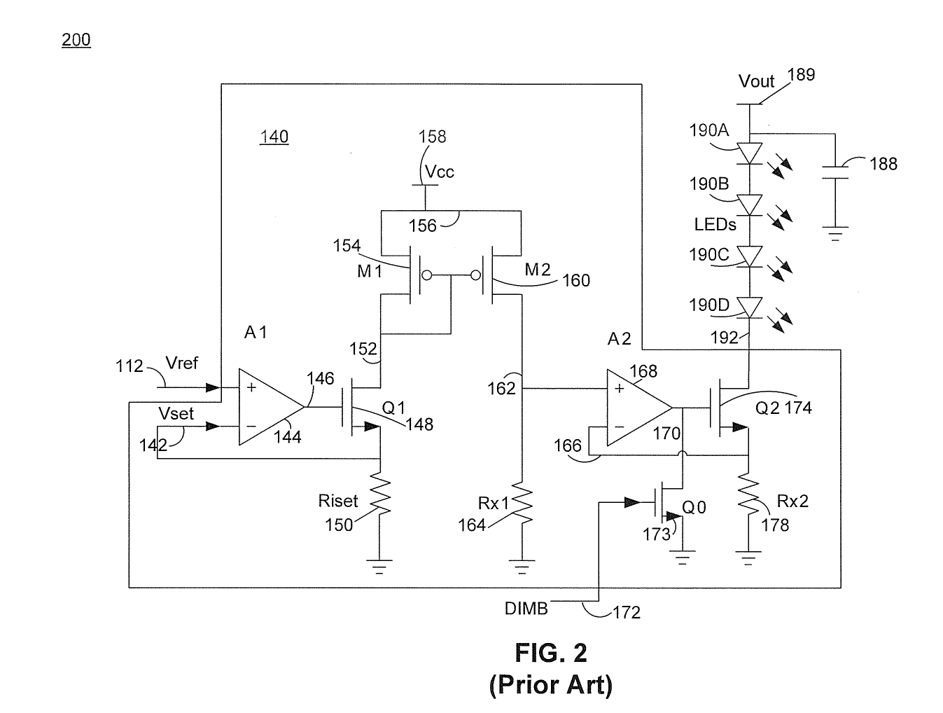

FIG. 2 is a schematic diagram illustrating an exemplary embodiment of an LED current controller 140 shown in FIG. 1. LED current controller 140 can receive a reference voltage Vref 112, for example, from bandgap and Vcc regulator 110 shown in FIG. 1. LED current controller 140 can also receive a dimming control signal DIMB 172. DIMB 172 can be the same as PWM input 102C in FIG. 1 or a signal derived therefrom. LED current controller 140 can include an operational amplifier 144, a transistor Q1 148, a resistor Riset 150, a transistor M1 154, a transistor M2 160, a resistor Rx1 164, an operational amplifier 168, a transistor Q0 173, a transistor Q2 174, and a resistor Rx2 178. LED current controller 140 can be electrically coupled to LEDs 190A˜190D through connection 192.

As discussed above, in some embodiments, the reference voltage Vref 112 can be generated from bandgap and Vcc regulator 110 and thus can be any desired value. In FIG. 2, operational amplifier 144 receives Vref 112 and Vset 142 as its input signals and generates an output signal 146 to control a gate terminal of transistor Q1 148. Operational amplifier 144 can enforce Vset 142 to be equal to or substantially equal to Vref 112, depending on the characteristics of operation amplifier 144, such as its gain, input frequency range, etc. Operational amplifier 144, transistor Q1 148, and resistor Riset 150 form a feedback loop, which dynamically adjusts Vset 142 to closely track Vref 112. Thus, the current flowing through transistor Q1 148 can be equal to the voltage value of Vref 112 divided by the resistance value of resistor Riset 150. This current can be the same as, or substantially the same as, the current flowing through transistor M1 154. Transistor M1 154 and transistor M2 160 form a current mirror. Current flowing through transistor M2 160 can closely follow that of transistor M1 154, depending on the current gain ratio (M2/M1) of the current mirror, which is related to relative dimensions of the gate of transistor M1 154 and transistor M2 160. For example, if transistor M1 154 and transistor M2 160 are identical, current flowing through the two transistors are the same or substantially the same.

In some embodiments, resistor Rx1 164 can convert current flowing through transistor M2 160 to a voltage signal 162, which is one of the input signals to operational amplifier 168. Operational amplifier 168 has a second voltage input 166. Operational amplifier 168 can enforce the voltage 166 to be equal to or substantially equal to the voltage 162, depending on the characteristics of operation amplifier 168, such as its gain, input frequency range, etc. The output signal 170 of operation amplifier 168 is electrically coupled to a gate terminal of transistor Q2 174. A source terminal of transistor Q2 174 is connected to resistor Rx2 178. When transistor Q2 174 is turned on, the current flowing through transistor Q2 174 and resistor Rx2 178 can be determined to be equal to, or substantially equal to, the voltage 162 divided by the resistance value of resistor Rx2 178. Consequently, since LEDs 190A˜190D are electrically coupled to the drain terminal of transistor Q2 174, the current flowing through the LEDs can be the same as, or substantially the same as, the current flowing through transistor Q2 174 and resistor Rx2 178.

Further, in FIG. 2, as discussed above, Vref 112 can determine the current flowing through resistor Riset 150. And this current is mirrored or multiplied by the transistor M1 and transistor M2 pair. Therefore, the current flowing through resistor Rx1 164 can be determined by the voltage value of Vref 112 and the current gain ratio (M2/M1) of the current mirror. Later, the current flowing through the resistor Rx2 178 can also be determined through the current-voltage conversion by resistor Rx1 and through the function of operational amplifier 168. Thus, the current flowing through LEDs 190A˜190D can be expressed as: iLED=(Vref/Riset)×(M2/M1)×(Rx1/Rx2)=K×(Vref/Riset), where K=(M2/M1)×(Rx1/Rx2). If transistor M1 154 and transistor M2 160 are identical, K=(Rx1/Rx2).

As shown in FIG. 2, DIMB 172 can be the same as or derived from PWM input 102C shown in FIG. 1. As discussed above, PWM input 102C can be a PWM signal, and thus DIMB 172 can also be a PWM signal. When DIMB 172 is at a low voltage level, transistor Q0 173 can be turned off and LED current controller 140 operates to supply foregoing calculated iLED current to LEDs 190A˜190D. Conversely, when DIMB 172 is at a high voltage level, transistor Q0 173 can be turned on and voltage 170 is pulled toward the ground potential. Consequently, transistor Q2 174 can be turned off, and the current supply to LEDs 190A˜190D can be reduced or eliminated. Thus, by adjusting the control signal DIMB 172—for example, adjusting its pulse width—the LED control circuit can adjust the current passing through LEDs 190A˜190D and thus adjust the light intensity. As discussed earlier, this method can result in a significant output voltage fluctuation, and consequently, the current flowing through LEDs 190A˜190D (i.e., the LED load current) can experience a large ripple effect.

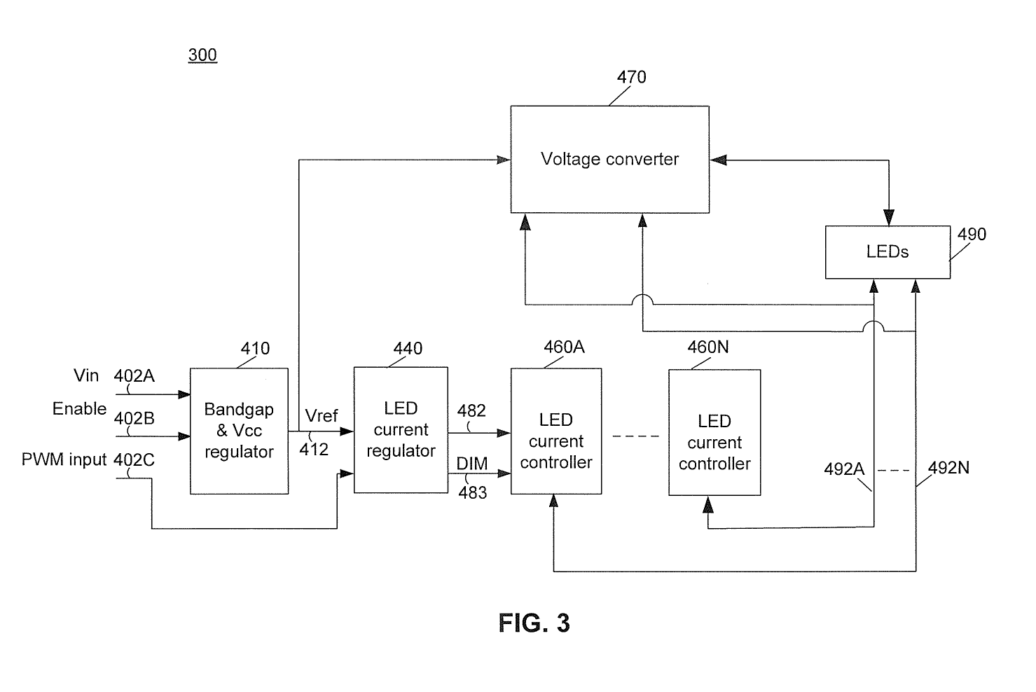

FIG. 3 is a block diagram of an exemplary LED control system 300 having an LED current regulator 440. In FIG. 3, it will be readily appreciated by one of ordinary skill in the art that the illustrated blocks and circuit elements can be altered in their numbers or their relative positions. LED control system 300 can also include additional blocks or circuit elements.

LED control system 300 can have one or more input signals including, for example, a voltage signal Vin 402A, an enable signal 402B, and a PWM input 402C. LED control system 300 can also include a bandgap and Vcc regulator 410, an LED current regulator 440, one or more LED current controllers 460A˜460N, a voltage converter 470, and LEDs 490. For example, the system can have any number of LED arrays, and hence corresponding number of LED current controllers. In FIG. 3, the LED control system 300 is illustrated in block diagram. A person having ordinary skill in the art should appreciate that the blocks are divided for illustration purpose; and the functional blocks may be integrated on the actual circuit.

As shown in FIG. 3, bandgap and Vcc regulator 410 can receive external signals including voltage signal Vin 402A and enable signal 402B. When enable signal 402B is high, for example, bandgap and Vcc regulator 410 can generate a reference voltage Vref 412 and an internal power supply Vcc (not shown in FIG. 3), which is a more stable power supply voltage compared with an outside power supply voltage. Vref 412 can be an input signal to both LED current regulator 440 and voltage converter 470.

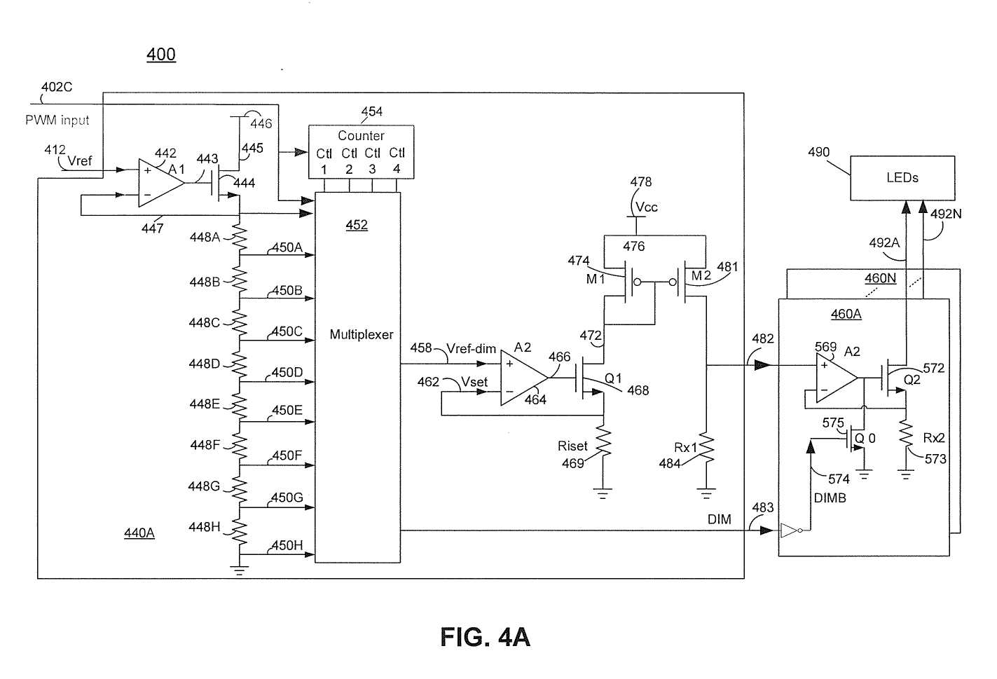

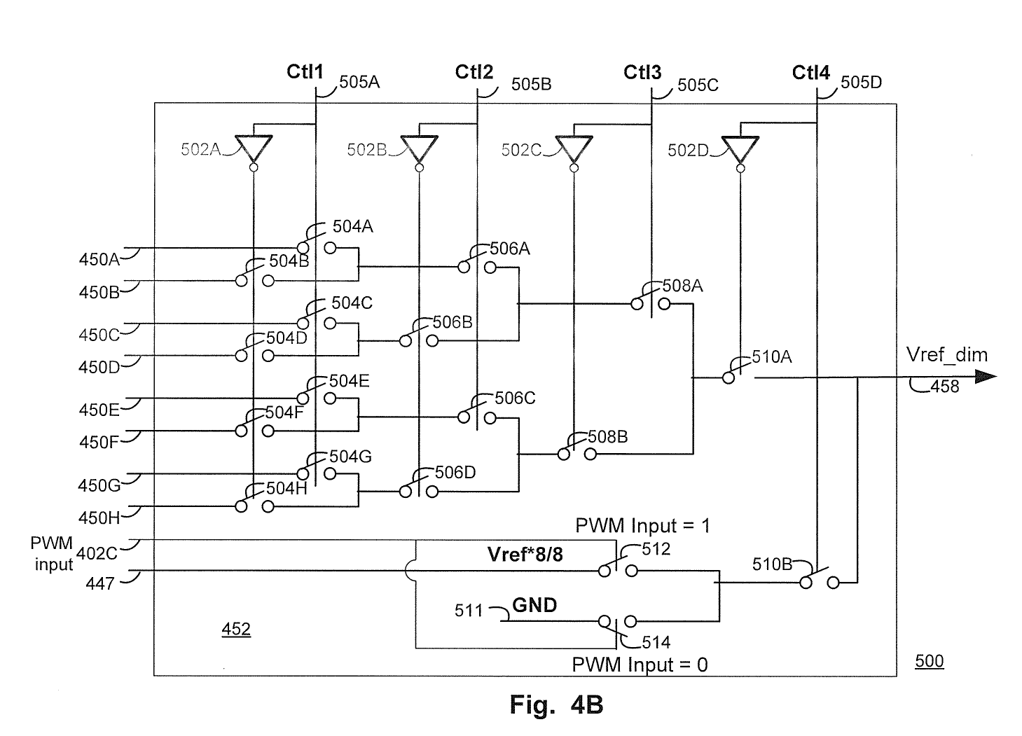

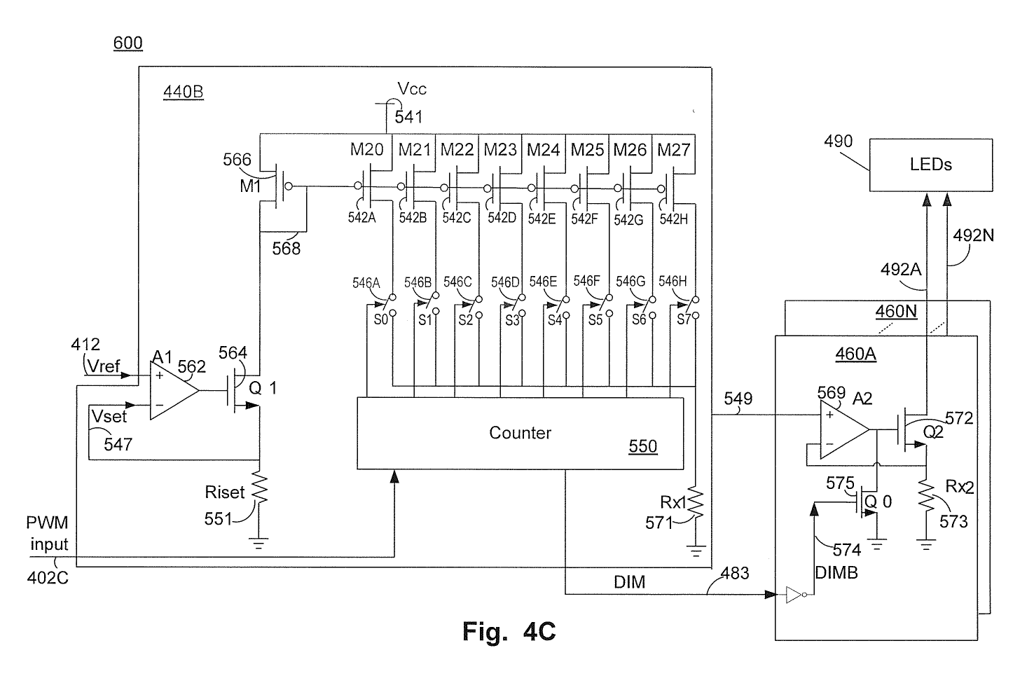

LED current regulator 440 can receive reference voltage Vref 412 and PWM input 402C. Similar to PWM input 102C in FIG. 1, PWM input 402C can be a PWM signal. LED current regulator 440 can generate output signals including a voltage signal 482 and a control signal DIM 483. Signals 482 and 483 can be input signals to one or more LED current controllers 460A˜460N, which form part of the current path through the LEDs 490 and voltage converter 470. LEDs 490 can include one or more light emitting diodes the same as, or similar to, those shown in FIG. 1, i.e., LEDs 190A˜190D. The details of LED current regulator 440 will be discussed below in association with FIGS. 4A˜4C. Signal 482 can be controlled to increase or decrease in a desirable manner so that the output currents from LED current controllers 460A˜460N (i.e., the currents flowing through LEDs 490) are also controlled in a desirable manner. Consequently, the output voltage fluctuation and ripple effect can be reduced or avoided. For example, signal 482 can increase or decrease in eight relatively small steps until it reaches its final value. As a result, the current flowing through LEDs 490 can also change gradually, i.e., in eight relatively small steps. Therefore, significant fluctuations of the output voltage or ripple effect can be reduced or avoided. Signal DIM 483 can be a control signal similar to PWM input signal 402C, or derived therefrom. Signal DIM 483 can control the on or off of LED current controllers 460A˜460N.

Further, in FIG. 3, LED current controllers 460A˜460N can be any type, for example, the same or similar type as LED current controller 140 or part of LED current controller 140 shown in FIG. 1. As an example, referring to LED current controller 140 in FIG. 2, LED current controllers 460A˜460N in FIG. 3 may include only circuit elements corresponding to operational amplifier 168, transistor Q0 173, transistor Q2 174, and resistor Rx2 178, but may not include the remaining circuit elements in FIG. 2. The remaining circuit elements shown in FIG. 2 may be included in LED current regulator 440 in FIG. 3, as will be discussed in details below in association with FIG. 4A. The circuit elements included in LED current controllers 460A˜460N can be connected in the same or similar way and thus have the same or similar functions as their counterparts in FIG. 2. Therefore, their descriptions are not repeated here. The output signals from LED current controllers 460A˜460N can be provided to voltage converter 470 directly or indirectly through connections 492A˜492N as feedback signals.

As shown in FIG. 3, voltage converter 470 can be any type, for example, the same or a similar type as boost controller 120 as shown in FIG. 1. Voltage converter 470 can be a boost converter, which generates an output signal having a voltage level higher than that of the input signal. Voltage converter 470 can also be a buck converter, which generates an output signal having a voltage level lower than that of the input signal. Moreover, voltage converter 470 can be a buck-boost converter, which generates an output signal having a voltage level either higher or lower than that of the input signal.

FIG. 4A is a schematic diagram of an exemplary LED current regulator 440A corresponding to LED current regulator 440 shown in FIG. 3. In FIG. 4A, it will be readily appreciated by one of ordinary skill in the art that the illustrated blocks and circuit elements can be altered in their numbers (e.g., the number of resistors are not limited to eight as shown in FIG. 4A) or their relative positions; and LED current regulator 440A can further include additional blocks or circuit elements.

In FIG. 4A, LED current regulator 440A can receive one or more input signals including, for example, PWM input 402C and Vref 412 from bandgap and Vcc regulator 410 as shown in FIG. 3. LED current regulator 440A can include an operational amplifier 442, a transistor 444, a power supply 446, a voltage divider including two or more resistors such as 448A˜448H, and a selection circuit, which includes a multiplexer 452 and a counter 454. LED current regulator 440A can generate one or more output signals including a voltage signal 482 and a control signal DIM 483.

As shown in FIG. 4A, in some embodiments, operational amplifier 442 can receive Vref 412 and enforce the voltage 447 to be equal to or substantially equal to voltage Vref 412 in a similar way as discussed in association with operational amplifier 144 in FIG. 2, depending on the characteristics of operation amplifier 442, such as its gain, input frequency range, etc. Operational amplifier 442 has an output voltage 443, which is connected to a gate terminal of transistor 444. The current flowing through transistor 444 can be determined by the voltage value of Vref 412 divided by the resistance value of a sum of resistors 448A˜448H. In some embodiments, resistors 448A˜448H can have resistance values on the ten kilo-ohm (10 KΩ), twenty kilo-ohm (20 KΩ) or thirty kilo-ohm (30 KΩ) scales. The current flowing through resistors 448A˜448H can be the same as, or substantially the same as, the current flowing through transistor 444.

Further in FIG. 4A, the voltages 450A˜450H are intermediate voltages between the resistors and can be fractions of the voltage 447, i.e., fractions of the voltage Vref 412. For example, if the eight resistors 448A˜448H, each having the same resistance value, are used as shown in FIG. 4A in the resistor network, the voltage 450G is ⅛ of Vref 412, the voltage 450F is 2/8 of Vref 412, and so forth. It can be readily appreciated by one skilled in the art that the number of resistors in the network is not restricted to eight, but can be any number greater than one. In some embodiments, for example, the number of resistors can be an integer between two and sixteen. Moreover, the resistance values of resistors 448A˜448H are not required to be equal to each other and can be different in any manner desired. It can also be readily appreciated by one skilled in the art that the input signals to multiplexer 452 can be arranged in anyway desired.

In some embodiments, multiplexer 452 can receive signals 450A˜450H, voltage 447 and PWM input 402C as its input signals and generate output signals including voltage Vref−dim 458. The voltage Vref−dim 458 can be selected or derived from the voltages 450A˜450H, voltage 447, and an electrical ground. For example, the voltage Vref−dim 458 can be selected to be equal to or substantially equal to any of the voltages 450A˜450H, depending on the control signals (e.g., Ctl1˜Ctl4) from counter 454. Vref−dim 458 can also be further refined to be equal to any voltage between ground and voltage 447 (i.e., the voltage Vref 412 or the voltage that is substantially similar to that of Vref 412). As an example, multiplexer 452 can interpret voltages 450A and 450B, either linearly or nonlinearly, and generate the voltage Vref−dim 458 to be any voltage between ⅞ of Vref 412 and 6/8 of Vref 412. An exemplary embodiment of multiplexer 452 will be discussed in association with FIG. 4B.

Multiplexer 452 can be controlled by any logic including, for example, by counter 454. Counter 454 is electrically coupled to multiplexer 452 and can be any type of counters such as up/down counter, asynchronous (ripple) counter, synchronous counter, etc. Counter 454 can be binary coded, Gray coded, or coded with any other type of coding.

In some embodiments, counter 454 can receive a control signal to initiate counting, stop counting, or reset the counter. One example of the control signal can be PWM input 402C or a signal derived therefrom. For example, when PWM input 402C falls, counter 454 can initiate counting. During counter 454's first counting period, multiplexer 452 can select signal 450A (i.e., ⅞ of Vref 412) and generate the voltage Vref−dim 458 to be equal to or substantially equal to the voltage 450A. During counter 454's second counting period, multiplexer 452 can select voltage 450B (i.e., 6/8 of Vref 412), and during the third counting period, select voltage 450C (i.e., ⅝ of Vref 412), and so forth. When the voltage Vref−dim 458 reaches voltage 450H, counter 454 can stop counting. The selection of signals 450A˜450H can be controlled by signals such as Ctl1˜Ctl4 from counter 454. The details of an exemplary counter 454 will be discussed in association with FIG. 4B.

In some embodiments, Vref−dim 458 can be an input reference voltage to the subsequent circuits similar to those shown in FIG. 2. That is, Vref−dim 458 can replace Vref 112 as shown in FIG. 2. In other words, operational amplifier 464, transistor Q1 468, resistor Riset 469, transistor M1 474, transistor M2 481, and resistor Rx1 484, can correspond to their respective counterparts in FIG. 2, i.e., operational amplifier 144, transistor Q1 148, resistor Riset 150, transistor M1 154, transistor M2 160, and resistor Rx1 164. Therefore, the functions of these circuit elements in LED current regulator 440A are not repeated.

LED current regulator 440A can generate an output voltage signal 482, which can be the input to one or more LED current controllers 460A˜460N. Each of LED current controllers 460A˜460N can include an operational amplifier 569, a transistor Q0 575, a transistor Q2 572, and a resistor Rx2 573, corresponding to operational amplifier 168, transistor Q0 173, transistor Q2 174, and resistor Rx2 178 as shown in FIG. 2, respectively. That is, LED current controllers 460A˜460N can be similar to the corresponding part of LED current controller 140 as shown in FIG. 2 and thus the functions of these circuit elements are not repeated.

As discussed above, Vref−dim 458 can replace Vref 112 as the input reference voltage shown in FIG. 2. Thus, similar to the discussion earlier that referred to FIG. 2, current flowing through the LEDs 490 can now be controlled by Vref−dim 458, instead of Vref 112. That is, iLED=(Vref−dim/Riset)×(M2/M1)×(Rx1/Rx2)=K×(Vref−dim/Riset), where K=(M2/M1)×(Rx1/Rx2). If transistor M1 474 and transistor M2 481 are identical, K=(Rx1/Rx2). As seen in the above equation, the current passing through the LEDs (iLED) is proportional to Vref−dim. Therefore, during the process of turning off the current flowing through LEDs 490 (i.e., iLED), counter 454 and multiplexer 452 can select the voltage levels from high to low, and the current can decrease in smaller steps corresponding to ⅞, 6/8, ⅝ . . . ⅛ of Vref, until the current decreases to zero. It is readily appreciated by those skilled in the art that the LED current iLED can decrease at any step desired, linear or nonlinear, and is not restricted to the eight steps corresponding to the eight voltage levels divided by the resistance value of a sum of resistors 448A˜448H.

In some embodiments, when PWM input 402C rises, counter 454 can also initiate counting. During counter 454's first counting period, multiplexer 452 can select voltage 450H (i.e., the ground potential) and generate the voltage Vref−dim 458 to be equal or substantially equal to the voltage 450H. During counter 454's second counting period, multiplexer 452 can select voltage 450G (i.e., ⅛ of Vref 412), and during the third counting period, select voltage 450F (i.e., 2/8 of Vref 412), and so forth. Counter 454 can stop counting when voltage 450A (i.e., ⅞ of Vref 412) is selected and the voltage Vref−dim 458 equals or substantially equals to the voltage 450A. Or counter 454 can stop counting when voltage 447 is selected and the voltage Vref−dim 458 equals or substantially equals to voltage 447 (i.e., the voltage Vref 412). Because the current flowing through LEDs 490 (i.e., iLED) corresponds to the voltage Vref−dim 458, as counter 454 and multiplexer 452 select the voltage levels from low to high, the LED current iLED can increase in smaller steps, until it reaches its final value. It is readily appreciated that iLED can be controlled to increase or decrease in any manner desired, linearly or nonlinearly, and is not restricted to the eight steps corresponding to the eight resistors 448A˜448H as shown in FIG. 4A.

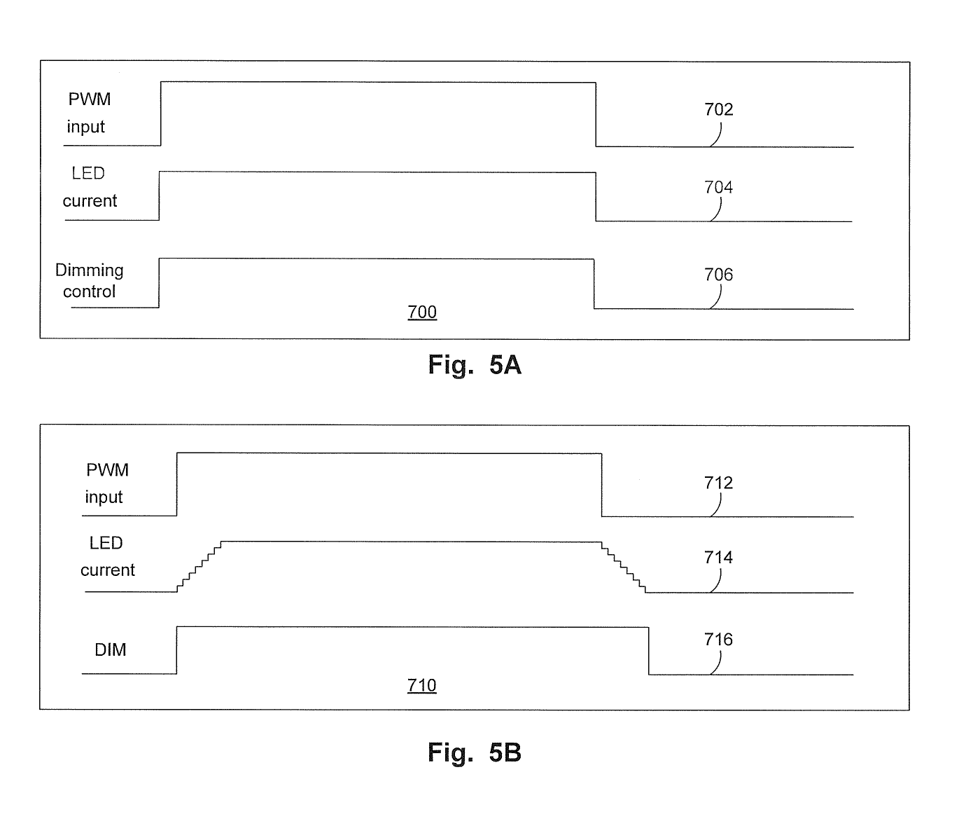

Further, in FIG. 4A, LED current controllers 460A˜460N can also receive a dimming control signal DIM 483 from LED current regulator 440A. DIM 483 can have, for example, a waveform 716 as shown in FIG. 5B. The dimming control signal DIM 483, which can be derived from PWM input 402C, can generate a signal such as DIMB 574 for controlling transistor Q0 575. DIM 483 can rise when PWM input 402C rises, i.e., when the current of LEDs 490 rises above its initial level. DIM 483 may fall to a low voltage level when current flowing through LEDs 490 (i.e., iLED) falls back to its initial level (also referring to waveform 716 in FIG. 5B). This allows LED current controller 460A˜460N to continue supplying current to LEDs 490 corresponding to the voltage level of signal 482. As will be explained below, DIMB 574, derived from DIM 483, can turn on and turn off LEDs 490 shown in FIG. 3.

As shown in FIG. 4A, in LED current controllers 460A˜460N, DIMB 574 is coupled to a gate terminal of transistor Q0 575. A drain terminal of transistor Q0 575 is electrically coupled to a gate terminal of transistor Q2 572, and a source terminal of transistor Q0 575 is coupled to the ground potential. A drain terminal of transistor Q2 572 is coupled to LEDs 490 through connections such as 492A, and a source terminal of transistor Q2 572 is coupled to the ground through resistor Rx2 573. When DIMB 574 is high, transistor Q0 575 is turned on, the voltage of the drain terminal of transistor Q0 575 is pulled toward ground, and transistor Q2 572 is turned off. Consequently, the current flowing through LEDs 490 (shown in FIG. 3) can be reduced or eliminated. When DIMB 574 is low, transistor Q0 575 is turned off, the voltage of the drain terminal of transistor Q0 575 is high, and transistor Q2 572 is on. The current flowing through the LEDs 490 can flow through resistor Rx2 to the ground potential.

FIG. 4B is a schematic diagram of an exemplary multiplexer 452 shown in FIG. 4A. Multiplexer 452 can include one or more inverters 502A˜502D, one or more switches 504A˜504H controlled by an input signal Ctl1 505A, one or more switches 506A˜506D controlled by an input signal Ctl2 505B, one or more switches 508A 508B controlled by an input signal Ctl3 505C, and one or more switches 510A˜510B controlled by an input signal Ctl4 505D. Multiplexer 452 can also include additional logics or circuits such as switches 512 and 514. Further, in FIG. 4B, it will be readily appreciated by one of ordinary skill in the art that the illustrated blocks and circuit elements can be altered in their numbers or their relative positions. For Example, the multiplexer 452 is not limited to have four control signals CM 505A˜Ctl4 505D and eight voltage levels corresponding to the signals 450A˜450H.

As shown in FIG. 4B, in some embodiments, multiplexer 452 can take, for example, signals 450A˜450H as its input signals and generate an output signal Vref_dim 458 based on the control signals Ctl1 505A˜Ctl4 505D. For example, when the dimming control is initiated, PWM input 402C can rise to a high voltage level (i.e., PWM input 402C=1). The corresponding control signal DIM 483 (shown in FIG. 4A) can also rise immediately, and turn on LED current controllers 460A˜460N by turning off transistor Q0 575 as discussed above in FIG. 4A. Counter 454 shown in FIG. 4A can thus start counting from “0000,” i.e., signals Ctl4 505D˜CM 505A=“0000,” respectively. Switches 504H, 506D, 508B, and 510A are closed and thus the voltage of the output signal Vref_dim 458 equals or substantially equals to voltage 450H (i.e., ⅛ of Vref 412). When counter 454 advances one counting period and “Ctl4Ctl3Ctl2Ctl1” equals “0001,” respectively, switches 504G, 506D, 508B, and 510A are closed and thus the voltage Vref_dim 458 equals or substantially equals voltage 450G (i.e., 2/8 of Vref 412). When “Ctl4Ctl3Ctl2Ctl1” equals “0010,” the voltage Vref_dim 458 equals or substantially equals voltage 450F, and so forth. When “Ctl4Ctl3Ctl2Ctl1” equals “0111,” the voltage Vref_dim 458 equals or substantially equals voltage 450A (i.e., ⅞ of Vref 412). Counter 454 may also count one more period such that when “Ctl4Ctl3Ctl2Ctl1” equals to “1000,” the voltage Vref_dim 458 equals voltage 447, i.e., 8/8 of Vref 412. Counter 454 can then stop counting. The logic relations of the input and the output signals for multiplexer 452 in FIG. 4B, as discussed above, are summarized in Table 1 below. It is readily appreciated by one of ordinary skill in the art that the logic relations shown in Table 1 are for illustration purpose only and any other logic can be designed to achieve the same or similar voltage selection purpose.

TABLE 1
Logic relations between input and output signals
shown in FIG. 4B, when PWM input 402C = 1.

| PWM | | | | | | |
|---|---|---|---|---|---|---|
| Input | Ctl1 | Ctl2 | Ctl3 | Ctl4 | Vref_dim | DIM |
| 1 | 0 | 0 | 0 | 0 | Vref * 1/8 | 1 |
| 1 | 1 | 0 | 0 | 0 | Vref * 2/8 | 1 |
| 1 | 0 | 1 | 0 | 0 | Vref * 3/8 | 1 |
| 1 | 1 | 1 | 0 | 0 | Vref * 4/8 | 1 |
| 1 | 0 | 0 | 1 | 0 | Vref * 5/8 | 1 |
| 1 | 1 | 0 | 1 | 0 | Vref * 6/8 | 1 |
| 1 | 0 | 1 | 1 | 0 | Vref * 7/8 | 1 |
| 1 | 1 | 1 | 1 | 0 | Vref * 8/8 | 1 |
| 1 | 0 | 0 | 0 | 1 | Vref | 1 |

In FIG. 4A, as another example, PWM input 402C falls to a low voltage level (i.e., PWM input 402C=0). The corresponding control signal DIM 483, however, may not fall to a low voltage level until the current flowing through LEDs 490 (i.e., iLED) falls back to its initial level (also referring to waveform 716 in FIG. 5B). This allows LED current controllers 460A˜460N to continue supplying current to LEDs 490 corresponding to the voltage level of signal 482.

In FIG. 4B, when PWM input 402C falls, counter 454 shown in FIG. 4A can start counting from, for example, “0111.” When “Ctl4Ctl3Ctl2Ctl1” (i.e., signals 505D 505A) equals “0111,” respectively, switches 504A, 506A, 508A, and 510A are closed and thus the voltage of the output signal Vref_dim 458 equals or substantially equals voltage 450A (i.e., ⅞ of Vref 412). When counter 454 advances one counting period and “Ctl4Ctl3Ctl2Ctl1” equals “0110,” respectively, switches 504B, 506A, 508A, and 510A are closed and thus the voltage Vref_dim 458 equals or substantially equals voltage 450B (i.e., 6/8 of Vref 412). When “Ctl4Ctl3Ctl2Ctl1” equals “0101,” the voltage Vref_dim 458 equals to substantially equals voltage 450C, and so forth. When “Ctl4Ctl3Ctl2Ctl1” equals “0000,” the voltage Vref_dim 458 equals or substantially equals voltage 450H (i.e., 0/8 of Vref 412). Counter 454 may also count one more period and when “Ctl4Ctl3Ctl2Ctl1” equals “1000,” the voltage Vref_dim 458 equals or substantially equals that of a ground signal GND 511. The ground signal GND 511 can be generated internally or externally to multiplexer 452. Counter 454 can then stop counting. The logic relations of input and output signals for multiplexer 452 shown in FIG. 4B, as discussed above, are summarized in Table 2 below. It is readily appreciated by one of ordinary skill in the art that the logic relations shown in Table 2 are for illustration purpose only and any other logic can be designed to achieve the same or similar voltage selection purpose.

TABLE 2
Logic relations between input and output signals
shown in FIG. 4B, when PWM input 402C = 0.

| PWM | | | | | | |
|---|---|---|---|---|---|---|
| Input | Ctl1 | Ctl2 | Ctl3 | Ctl4 | Vref_dim | DIM |
| 0 | 1 | 1 | 1 | 0 | Vref * 7/8 | 1 |
| 0 | 0 | 1 | 1 | 0 | Vref * 6/8 | 1 |
| 0 | 1 | 0 | 1 | 0 | Vref * 5/8 | 1 |
| 0 | 0 | 0 | 1 | 0 | Vref * 4/8 | 1 |
| 0 | 1 | 1 | 0 | 0 | Vref * 3/8 | 1 |
| 0 | 0 | 1 | 0 | 0 | Vref * 2/8 | 1 |
| 0 | 1 | 0 | 0 | 0 | Vref * 1/8 | 1 |
| 0 | 0 | 0 | 0 | 0 | Vref * 0/8 | 1 |
| 0 | 0 | 0 | 0 | 1 | GND | 0 |

In some embodiments, counter 454 shown in FIG. 4A can have a counting frequency in the range of 100 kHz˜1 MHz for the Ctl1 output signal. That is, the output signal Ctl1 505A, which is the fastest switching output signal among the four signals Ctl1˜Ctl4, can switch at the frequency of 100 kHz˜1 MHz. Signals Ctl2, Ctl3 and Ctl4, for example, can then be switching at a frequency that is a fraction of the Ctl1 frequency. For example, Ctl2 505B can have a switching frequency of 50 KHz˜500 Khz, Ctl3 505C can have a switching frequency of 25 KHz˜250 Khz, and so forth. It is readily appreciated by one skilled in the art that the switching frequencies of the control signals Ctl1, Ctl2, Ctl3 and Ctl4 can also have other desired relations.

FIG. 4C is a schematic diagram of another exemplary LED current regulator 440B corresponding to the LED current regulator 440 as shown in FIG. 3. In FIG. 4C, it will be readily appreciated by one of ordinary skill in the art that the illustrated blocks and circuit elements can be altered in their numbers (e.g., number of slave stages of the current mirror transistors are not limited to eight as shown in FIG. 4C) or their relative positions. LED current regulator 440B can further include additional blocks or circuit elements.

In FIG. 4C, LED current regulator 440B can include a power supply 541, an operational amplifier 562, a resistor Riset 551, a transistor Q1 564, a transistor M1 566, two or more transistors 542A˜542H, two or more switches 546A˜546H, a selection circuit, which includes a counter 550, and a resistor Rx1 571. LED current regulator 440B can receive one or more input signals including, for example, PWM input 402C and Vref 412, and generate one or more output signals including a dimming control signal DIM 483 and a voltage signal 549.

Similar to that in FIG. 4A, operational amplifier 562 in FIG. 4C can enforce the voltage Vset 547 to be equal to or substantially equal to that of Vref 412, depending on the characteristics of operation amplifier 562, such as its gain, input frequency range, etc. Thus, the current flowing through transistor Q1 564 and transistor M1 566 can be equal to or substantially equal to the voltage value of Vref 412 divided by the resistance value of resistor Riset 551. This current can be mirrored to the slave transistors M20 542A˜M27 542H. The control terminals of the master transistor M1 566 and the slave transistors M20 542A˜M27 542H are connected to each other. Thus, the current flowing through the slave transistors M20 542A˜M27 542H can closely follow the current in the master transistor M1 566, depending on the current gain ratio (M20˜M27/M1) of the current mirror, which is related to relative gate dimensions of the master transistor M1 566 and the slave transistors M20 542A˜M27 542H. As an example, if switch 546A is closed and the slave transistor M20 542A is identical to the master transistor M1 566, the current flowing through M20 542A can be equal or substantially equal to that flowing through transistor M1 566. Similarly, if any other switches S1 546B˜S7 546H are closed, current can flow through these slave transistors M21 542B˜M27 542H in relation to the current of transistor M1 566.

In some embodiments, switches 546A˜546H can be controlled by any logic including, for example, by counter 550. Counter 550 can be any type of counter such as up/down counter, asynchronous (ripple) counter, synchronous counter, etc. Counter 550 can be binary coded, Gray coded, or coded with any other type of coding.

Further, in FIG. 4C, counter 550 can receive control signals to initiate counting, stop counting or reset the counter. One example of the control signal can be PWM input 402C. For example, when PWM input 402C rises to a high voltage level, counter 550 can initiate counting. The corresponding control signal DIM 483 also rises immediately, turning on LED current controllers 460A˜460N by turning off transistor Q0 575 as discussed above.

In operation, all switches S0 546A˜S7 546H may be disconnected so that no current can flow. During counter 550's first counting period, switch S0 546A can be closed so that the total current flowing through transistors M20 542A˜M27 542H can be increased by the current flowing through transistor M20 542A. For example, if all of the slave transistors M20 542A˜M27 542H are identical, then the total current is increased by ⅛. During counter 550's second counting period, switch S1 546B can be closed so that the total current can be further increased by the current flowing through transistor M21 542B (e.g., increased by another ⅛), and so forth. When all switches S0 546A˜S7 546H are closed, the total current can be increased to a desired level (e.g., a current level that is required for LEDs 490 to have the highest light intensity) and counter 550 can then stop counting. The total current flowing through resistor Rx1 571 is the same as, or substantially the same as, the total current flowing through switches S0 546A˜S7 546H. The relations between input and output signals of counter 550, when PWM input 402C=1, are shown in Table 3 below.

TABLE 3
Relations between input and output signals of counter 550,
when PWM input 402C = 1.

| PWM | | | | | | | | | |
|---|---|---|---|---|---|---|---|---|---|
| input | S7 | S6 | S5 | S4 | S3 | S2 | S1 | S0 | DIM |
| 1 | 0 | 0 | 0 | 0 | 0 | 0 | 0 | 1 | 1 |
| 1 | 0 | 0 | 0 | 0 | 0 | 0 | 1 | 1 | 1 |
| 1 | 0 | 0 | 0 | 0 | 0 | 1 | 1 | 1 | 1 |
| 1 | 0 | 0 | 0 | 0 | 1 | 1 | 1 | 1 | 1 |
| 1 | 0 | 0 | 0 | 1 | 1 | 1 | 1 | 1 | 1 |
| 1 | 0 | 0 | 1 | 1 | 1 | 1 | 1 | 1 | 1 |
| 1 | 0 | 1 | 1 | 1 | 1 | 1 | 1 | 1 | 1 |
| 1 | 1 | 1 | 1 | 1 | 1 | 1 | 1 | 1 | 1 |

As another example, when PWM input 402C falls from a high voltage level to a low voltage level, counter 550 can also initiate counting. The corresponding control signal DIM 483, however, may not fall until the total current flowing through LEDs 490 falls to its initial level. That is, signal DIM 483 falls only after all switches 546A˜546H are disconnected, and LED current controllers 460A˜460N are turned off so that no current is supplied to LEDs 490. This allows LED current controllers 460A˜460N to continue supplying current to LEDs 490 corresponding to the voltage level of signal 549, which reflects the total current flowing through the slave transistors M20 542A˜M27 542H.

Further, in FIG. 4C, initially, all switches S0 546A˜S7 546H may be closed so that current is flowing through all these switches. During counter 550's first counting period, switch S7 546H can be disconnected so that the total current flowing through transistors M20 542A˜M27 542H can be reduced by the current flowing through transistor M27 542H. For example, if all of the slave transistors M20 542A˜M27 542H are identical, then the total current is reduced by ⅛. During counter 550's second counting period, switch S6 546G can be disconnected so that the total current flowing through transistors M20 542A˜M27 542H can be further reduced by the current flowing through transistor M26 542G (e.g., reduced by another ⅛), and so forth. When all switches S0 546A˜S7 546H are disconnected, the total current can be reduced to zero or close to zero and counter 550 can then stop counting. Because resistor Rx1 571 is electrically coupled to switches S0 546A˜S7 546H, the total current flowing through Rx1 571 is the same as, or substantially the same as, the total current flowing through switches S0 546A˜S7 546H. The relations between input and output signals of counter 550, when PWM input 402C=0, are shown in Table 4 below.

TABLE 4
Relations between input and output signals of counter 550,
when PWM input 402C = 0.

| PWM | | | | | | | | | |
|---|---|---|---|---|---|---|---|---|---|
| Input | S7 | S6 | S5 | S4 | S3 | S2 | S1 | S0 | DIM |
| 0 | 0 | 1 | 1 | 1 | 1 | 1 | 1 | 1 | 1 |
| 0 | 0 | 0 | 1 | 1 | 1 | 1 | 1 | 1 | 1 |
| 0 | 0 | 0 | 0 | 1 | 1 | 1 | 1 | 1 | 1 |
| 0 | 0 | 0 | 0 | 0 | 1 | 1 | 1 | 1 | 1 |
| 0 | 0 | 0 | 0 | 0 | 0 | 1 | 1 | 1 | 1 |
| 0 | 0 | 0 | 0 | 0 | 0 | 0 | 1 | 1 | 1 |
| 0 | 0 | 0 | 0 | 0 | 0 | 0 | 0 | 1 | 1 |
| 0 | 0 | 0 | 0 | 0 | 0 | 0 | 0 | 0 | 0 |

As shown in FIG. 4C, LED current regulator 440B generates an output signal 549. Signal 549 is a voltage signal that is converted by resistor Rx1 571 from the total current flowing through the slave transistors M20 542A˜M27 542H of the current mirrors. Signal 549 can be an input to one or more LED current controllers 460A 460N. Each of LED current controllers 460A˜460N can include an operational amplifier 569, a transistor Q0 575, a transistor Q2 572, and a resistor Rx2 573, corresponding to operational amplifier 168, transistor Q0 173, transistor Q2 174, and resistor Rx2 178 as shown in FIG. 2, respectively. That is, LED current controllers 460A˜460N can be same as or similar to the corresponding portion of LED current controller 140 as shown in FIG. 2 and thus the descriptions of these elements in LED current controllers 460A˜460N are not repeated.

As shown in FIG. 4C, LED current controllers 460A˜460N can also receive a dimming control signal DIM 483 generated from LED current regulator 440B, similar to that in FIG. 4A. DIM 483 can have a waveform 716 as shown in FIG. 5B. The dimming control signal DIM 483, which can be derived from PWM input 402C, can generate a signal DIMB 574 for controlling transistor Q0 575. DIM 483 can start to rise when PWM input 402C rises, i.e., when the current of LEDs 490 rises above its initial level. DIM 483 may not fall until the current of LEDs 490 gradually falls to its initial level. After DIM 483 falls, LED current controllers 460A˜460N are turned off.

Further, in FIG. 4C, the dimming control signal DIMB 574 is coupled to a gate terminal of the transistor Q0 575. A drain terminal of transistor Q0 575 is electrically coupled to a gate terminal of transistor Q2 572, and a source terminal of transistor Q0 575 is coupled to the ground potential. A drain terminal of transistor Q2 572 is coupled to LEDs 490 through signals such as 492A˜492N, and a source terminal of transistor Q2 572 is coupled to the ground through resistor Rx2 573. When the signal DIMB 574 is high, transistor Q0 575 is turned on, the voltage of the drain terminal of transistor Q0 575 is pulled toward ground, and transistor Q2 572 is turned off. Consequently, the current flowing through LEDs 490 can be reduced or eliminated. When the signal DIMB 574 is low, transistor Q0 575 is turned off, the voltage of the drain terminal of transistor Q0 575 is high, and transistor Q2 572 is on. The current flowing through LEDs 490 can be increased or maintained.

Further, in FIG. 4C and similar to the discussion above by referring to FIG. 2, current flowing through LEDs 490 can be expressed as iLED=K×(Vref/Riset), where K=(M20−M27/M1)×(Rx1/Rx2). The current value will depend on which of the switches 546A˜546H is closed.

FIG. 5A is an exemplary timing diagram illustrating timing relations between waveform 702 (corresponding to PWM input 102C shown in FIG. 1), waveform 704 (corresponding to the current flowing through LEDs 190A˜190D shown in FIG. 1), and waveform 706 (corresponding to the dimming control signal DIMB 172 shown in FIG. 2). In FIG. 5A, waveform 706 closely follows waveform 702. That is, waveform 706 rises when waveform 702 rises and falls when waveform 702 falls. As shown in FIG. 2, DIMB 172 controls turn-on and turn-off of the LED current controller 140. Therefore, the current flowing through LEDs 190A˜190D (i.e., iLED) can have a sudden change and exhibits only two current levels, i.e., a high current level and a low current level. The average LED current iLED I_{LED-AVG} can be calculated as I_{LED-AVG}=IL*D*T/T=IL*D, where IL is the maximum value of LED current, T is the period of PWM signal 102C, D is the duty cycle of the PWM signal 102C and D*T is the period of time that PWM signal 102C is high. An exemplary range of the frequency of PWM signal 102C can be from 200 Hz to 20 KHz.

FIG. 5B is an exemplary timing diagram illustrating timing relations between waveform 712 (corresponding to PWM input 402C shown in FIG. 3), waveform 714 (corresponding to the current flowing through LEDs 490 shown in FIG. 3), and waveform 716 (corresponding to the dimming control signal DIM 483 shown in FIG. 3). In FIG. 5B, waveform 716 rises when waveform 712 rises. Waveform of the dimming control signal DIM 483 (i.e., waveform 716), however, does not fall immediately after waveform of PWM input 402C (i.e., waveform 712) falls. Instead, it falls when the LED current iLED (i.e., waveform 714) falls to its initial level. And the LED current iLED, can rise or fall gradually as shown in FIG. 5B. In the example shown in FIG. 5B, LED current iLED rises or falls in eight smaller steps, corresponding to the eight voltage levels of signals 450A˜450H shown in FIG. 4A or the eight current levels of the slave current mirror stages M20 542A˜M27 542H shown in FIG. 4C.

Further, in FIG. 5B, the average value of LED current iLED can still be kept the same as that in the circuit shown in FIG. 1, but the undesired current fluctuation and ripple effect can be suppressed or eliminated. As an illustration, when the LED current iLED rises of falls in eight steps, the average LED current I_{LED-AVG} can be calculated as I_{LED-AVG}=IL*D*T*(⅛+ 2/8+⅜+ 4/8+⅝+ 6/8+⅞+ 8/8)+IL*D*T*(⅞+ 6/8+⅝+ 4/8+⅜+ 2/8+⅛+ 0/8)+IL*(D*T−8*D*T)=IL*D, where IL is the maximum value of the LED current, T is the period of the PWM input, D is the duty cycle of the PWM input, and D*T is the period of time that the PWM input is high.

In the preceding specification, the subject matter has been described with reference to specific exemplary embodiments. It will, however, be evident that various modifications and changes may be made without departing from the broader spirit and scope of the invention as set forth in the claims that follow. The specification and drawings are accordingly to be regarded as illustrative rather than restrictive. Other embodiments may be apparent to those skilled in the art from consideration of the specification and practice of the embodiments disclosed herein.

What is claimed is:

1. A method for controlling a current flowing through one or more light emitting diodes (LEDs) comprising:
receiving a Pulse Width Modulation (PWM) signal, which includes rising and falling edges;
receiving a first voltage signal;
generating a second voltage signal based on the PWM signal and the first voltage signal, wherein the second voltage increases gradually in response to one of the rising and falling edges of the PWM signal and decreases gradually in response to the other of the rising and falling edges of the PWM signal; and
providing a current to the one or more LEDs, wherein the current varies gradually according to the second voltage.

2. The method of claim 1, wherein the generating the second voltage includes generating a plurality of internal voltages, each of the plurality of internal voltages being less than or equal to the first voltage.

3. The method of claim 2, wherein generating the plurality of internal voltages including dividing the first voltage to multiple voltage levels and each of the plurality of internal voltages represents one of the multiple voltage levels.

4. The method of claim 2, wherein the generating the second voltage includes continuously selecting, among the plurality internal voltages, from a lowest voltage to a highest voltage, in response to one of the rising and falling edges of the PWM signal and continuously selecting, among the plurality internal voltages, from a highest voltage to a lowest voltage in response to the other edge of the PWM signal.

5. The method of claim 4, wherein continuously selecting among the plurality internal voltages is performed through a counter.

6. A method for controlling a current flowing through one or more light emitting diodes (LEDs) comprising:
receiving a Pulse Width Modulation (PWM) signal, which includes rising and falling edges;
receiving a voltage signal;
generating a first current based on the voltage signal;
generating a second current based on the first current and the PWM signal, wherein the second current increases gradually in response to one of the rising and falling edges of the PWM signal and decreases gradually in response to the other edge of the PWM signal; and
providing a third current to the one or more LEDs, wherein the third current varies gradually according to the second current.

7. The method of claim 6, wherein the generating a second current, comprising:
generating the second current through a current mirror, wherein the first current is an input of the current mirror, and the second current is an output of the current mirror, the second current including one or more internal currents, each corresponding to the first current through the current mirror.

8. The method of claim 7, wherein the generating a second current includes continuously increasing the number of the internal currents in response to one of the rising and falling edges of the PWM signal and continuously decreasing the number of the internal currents in response to the other edge of the PWM signal.

9. The method of claim 8, wherein the continuously increasing the number of the internal currents and decreasing the number of the internal currents are performed through a counter.

10. The method of claim 7, wherein the current mirror includes one transistor on one side of the current mirror, and a series of transistors connected in parallel on the other side of the current mirror.

11. A system for controlling a current flowing through one or more light emitting diodes (LEDs) comprising:
a voltage regulator configured to receive a first voltage signal;
a current regulator coupled to the voltage regulator and configured to generate a second voltage signal based on a PWM signal and the first voltage signal, the PWM signal including rising and falling edges, wherein the second voltage increases gradually in response to one of the rising and falling edges of the PWM signal and decreases gradually in response to the other of the rising and falling edges of the PWM signal; and
a current controller configured to provide a current to the one or more LEDs, wherein the current varies gradually according to the second voltage.

12. The system of claim 11, wherein the current regulator includes a voltage divider, which provides multiple internal voltage levels based on the first voltage.

13. The system of claim 12, wherein the voltage divider includes a plurality of resistors connected in series, and wherein each of the internal voltage levels is derived from one end of a resistor of the plurality of resistors.

14. The system of claim 12, wherein the current regulator includes a voltage selection circuit for selecting a voltage level from the multiple internal voltage levels.

15. The system of claim 15, wherein the voltage selection circuit includes a counter.

16. The system of claim 15, wherein voltage selection circuit includes a multiplexer connected to the counter.

17. A system for controlling a current flowing through one or more light emitting diodes (LEDs) comprising:
a voltage regulator configured to receive a voltage signal;
a current regulator configured to generate a first current based on the voltage signal and generate a second current based on the first current and a PWM signal, the PWM signal including rising and falling edges, wherein the second current increases gradually in response to one of the rising and falling edges of the PWM signal and decreases gradually in response to the other of the rising and falling edges of the PWM signal; and
a current controller configured to provide a third current to the one or more LEDs, wherein the third current varies gradually according to the second current.

18. The system of claim 17, wherein the current regulator includes a current mirror, wherein the first current is an input of the current mirror, and the second current is an output of the current mirror, the second current including one or more internal currents, each corresponding to the first current through the current mirror.

19. The system of claim 18, wherein the current regulator includes a current selection circuit configured to select one or more of the internal currents.

20. The system of claim 19, wherein the current selection circuit includes a counter.

21. The system of claim 18, wherein the current mirror includes one transistor on one side of the current mirror, and a series of transistors connected in parallel on the other side of the current mirror.
